(19) United States
(12) Patent Application Publication
(10) Pub. No.: US 2005/0286253 A1
(43) Pub. Date: Dec. 29, 2005

(54) Lightweight, stiff curved reflector and method for manufacturing same

(76) Inventor: Karlheinz Strobl, Mount Sinai, NY (US)

Correspondence Address: LILLIE LAW, LLC, 269 SOUTHPORT ST, RONKONKOMA, NY, 11779, US

(21) Appl. No.: 11/147,507

(22) Filed: Jun. 8, 2005

Related U.S. Application Data
(60) Provisional application No. 60/577,982, filed on Jun. 8, 2004.

(51) Int. Cl. F21V 7/00

(52) U.S. Cl. 362/341

(57) ABSTRACT

A reflector for improving front and rear projection systems and fiber optic light sources, comprising a curved optical surface and at least one flange surface having at least two portions of said flange surface rigidly connected at the edge of said optical surface at a high tilt angle, thereby providing a compression and stretching resistance in at least one direction and method for manufacturing the same.

### CROSS REFERENCE TO RELATED APPLICATION(S)

This application claims priority from U.S. Provisional Application having Ser. No. 60/577,982 and a filing date of 8 Jun. 2004.

### BACKGROUND

1. Field of Invention

The present invention is directed to the design and manufacturing of a lightweight, stiff, and curved reflector, particularly, for the incorporation with a thin rear projection display system, front projection display system, or fiber optic light source.

2. Description of Background

Generally, the consumer market has desired, inter alia, increasingly larger displays capable of displaying brighter and higher resolution image displays. In one particular market segment, the display screens on televisions (hereafter display units) have increased considerably over the last few decades. Moreover, while the viewing area of the display screens has increased, there has been a current trend to reduce the depth of the unit, (e.g., low profile flat screens wherein the depth of the unit approaches zero clearance; W×H×D where D is increasingly smaller).

However, as the image displays of the units have become larger, pragmatic issues, particularly manufacturing costs, have surfaced therefrom. For example, the increase in weight of a unit has also increased costs; inter alia, increased material, handling/shipping costs per unit, which in turn may incur safety issues, e.g., injuring ones back installing or moving such a conventionally large unit, or should the unit fall over onto an individual. Currently, the greater depth of the unit based on the current technology, the greater the handling/shipping costs, not to mention a greater allocation of floor space. Hence, these characteristics of contemporary large displays become a significant limitation to their usability, are undesirable, and hence should be minimized.

To reduce the depth of a rear projection display design beyond what is achievable with a flat folding mirror, a range of new projection display systems designs have been conceived that utilize curved reflectors to further reduce the depth of the rear projection display device. For example, U.S. Pat. No. 6,457,834 issued to C. T. Cotton et al. describes the use of a thin projection display system that uses a rectangular curved reflector to fold the light imaging path between a projection light engine and a special projection display screen with a light redirecting optical element.

In U.S. Pat. No. 6,631,994 issued to Suzuki et al. (hereafter Suzuki '994), the first stated objective thereof, is to provide an image display device that provides an enlarged display of distortion-free images and permits further reduction of its depth dimension than in the prior art. Although it is preferable to minimize the depth dimension of the image display device if the image size displayable is the same, Suzuki '994 appears to attempts to accomplish the depth minimization by incorporating alignment and distortion corrective techniques, but neither references nor addresses the characteristics of weight and rigidity of a mirror, nor methods of manufacturing such a mirror.

Moreover, others have disclosed that incorporating additional components, e.g., additional mirrors, is one approach to minimizing the depth of the overall unit. For example, in U.S. Pat. No. 6,561,656 B1 issued to Kojima et al, a small-sized, lightweight projector may be achieved by bending the optical path of the illumination optical system through the use of an additional reflecting mirror, or the like provided in the illumination optical system, thereby to make the arrangement of the components compact. However, this piece of art too fails to reference or address the advantages of a lightweight and rigid characteristic of a mirror.

However, while the use of such a curved mirror has been described in the literature no reference has been given as to how to design and/or manufacture such mirrors to make them economical, light weight, stiff, and of sufficient quality suitable for mass production.

Existing systems utilize a diamond turned reflector machined from a solid block of Aluminum, thereby making it expensive, heavy, and impractical for the consumer market. Alternatively, slumping of glass over a curved surface has been discussed prior to this application; however, the quality and production yields of the resulting surface shape have rendered this option of being implemented, impractical. Molding the surface with a plastic material into a conventional shape also poses significant quality problems due to the inherent material shrinkage and stress build up of the various moldable materials presently available. Moreover, the amount of materials needed to make this reflector structurally stable makes the resulting reflector heavy and too expensive for a mass production consumer application. This is particularly the case when the longest dimension of the curved reflectors is on the order of one meter (I m) and the widest dimension is approximately one-seventh ( 1/7th) of the longest dimension (here approximately 0.142 m), or when the optical surface has both concave and convex surface portions.

Alternatively, U.S. Pat. No. 6,527,396 issued to Shinji et. al. (hereafter Shinji '396) describes the use of a curved coupling reflector in order to optimize the coupling optic of a front projection display system. However, while this patent sets forth the benefit of such a design, it fails to shed light on the issue of how to design and/or manufacture said curved coupling reflector, so as incorporate the characteristics of being lightweight and stiff into such a reflector.

In other art, the output of a fiber optic light source is often coupled to an illumination target with a series of lenses and/or combination of lenses and/or homogenizers. This coupling focuses the beam, which is an optional characteristic. Moreover, the coupling further complicates the issue, by rendering the beam steering device mechanically heavy, and thus undesirable for fine surgical or for extended surgical light treatment applications.

Thus, the need exists for an improved curved reflector for an optical display system, particularly, a lightweight, stiff, curved mirror with a substantially rectangular form factor for use in combination with a projection display screen, whether rear or frontal, or fiber optic light source; in addition to as the existence of the need of methods of mass manufacturing the same.

It is an objective of the present invention to teach how to design a curved reflector with a mechanical stiff structure that has an optical surface and at the same time is both lightweight and has a high resistance to compression, tensile and tensional forces.

It is second objective of the present invention to present methods of manufacturing said mechanical structure in a mass producible manner.

It is a third objective of the present invention to utilize said curved reflector to manufacture thin, large rear projection display systems.

It is fourth objective of the present invention to utilize said stiffening mechanical design to improve the stiffness/mass ratio of other curved reflectors utilized within front and rear projection display systems, as well as within other optical imaging and illumination systems. It is further another objective of the present invention to utilize said stiffening mechanical design to improve the manufacturability of curved coupling reflectors for use with projection and fiber optic light sources.

Those and other advantages and benefits of the present invention will become apparent from the detailed description set forth herein below.

### SUMMARY OF THE INVENTION

The present invention is directed to an improved design and manufacturing methods of a curved reflector and its utilization in a front or rear projection display system, in particular, a thin projection display system with a high width to depth ratio (W/D>5) and as a coupling and beam steering optic in the light engine design of a projection display system and/or fiber optic light sources. In particular, it relates to curved reflectors comprising a curved optical surface and at least one flange surface with at least two portions of said flange surface mechanically rigid connected at the edge of said optical surface at a high tilt angle thereby providing a compression and stretching resistance in at least one direction.

The curved reflector of the present invention has substantially a rectangular or trapezoidal body, comprising an optical surface and preferentially two pairs of flange surfaces oriented substantially perpendicular to the optical surface, all said surfaces mechanically rigidly connected together along at least some portions near the edges of said optical surface and near the edges of the neighboring flange surface, and where said optical surface is curved at least in two dimensions and where all said optical and flange surfaces have substantially a similar uniform material thickness. The edges of all said oriented flange surfaces above or below to the optical surface together form a reference surface. The mechanical orientation and interconnection of all these surfaces provides a high stiffness to weight ratio and a high resistance to compressive and tensile deformation of the optical surface but low resistance to torsion deformation of said optical surface. The combination of said reference surface with a mating mounting surface provide a very high torsion resistance and a high torsion stiffness to weight ratio, thus providing a shape that is inherently light weight and stiff while simultaneously utilizing a minimum of material to provide these characteristics.

A preferred method of manufacturing such a shaped curved reflector is to manufacture said structure as a continuous shape with substantially homogeneous material thickness and with practically no mechanical interruptions between said optical and flange surface elements with either a Ni or an NiCo alloy electroforming copy process from a suitably shaped tool and/or molding, and stamping such a structure in a suitable press from a metal foil or moldable material source.

Another preferred method of the present invention is to manufacture said shape first by cutting, stamping, and/or machining, etc. metal foils into a suitable surface section, and then assembling said curved reflector from a plurality of surface sections, and to rigidly connecting them into the final curved reflector, while a suitable shaping tool stabilizes the optical surface section so that the correct curved surface shape is maintained, thus resulting in a substantially uniform thickness, light weight and stiff structure.

Preferred methods for said rigid connections of said shaped surface sections include, inter alia, gluing, spot welding, laser welding, arc welding, tack welding, crimping with connection guides, riveting, etc., thereby substantially mating surfaces together. Optionally each such surface can have bendable flanges and/or mounting slots that together can facilitate the mechanical rigid connection of the various surfaces sections while the optical section of the tool is being shaped (e.g., pressed) into the curved surface shape.

### BRIEF DESCRIPTION OF THE DRAWINGS

For the present invention to be clearly understood and readily practiced, the present invention shall be described in conjunction with the drawings set forth below:

FIG. 1 shows an isometric view depicting a LSCR on a mounting surface;

FIG. 2 shows an isometric view depicting a LSCR on a mounting surface with mounting post;

FIG. 3 shows the set of shapes cut from thin sheets of material;

FIG. 4 shows the set of shapes cut from thin sheets of material with mounting holes and slots;

FIG. 5 shows a schematic representation of the shaping for the optical surface from a foil;

FIG. 6 shows an isometric view depicting a LSCR assembled from multiple surface sections;

FIG. 7 shows an isometric view depicting a LSCR assembled from multiple surface sections with two mounting surfaces;

FIG. 8 shows a rear projection display system incorporating a LSCR;

FIG. 9 shows a front projection display systems incorporating a LSCR; and

FIG. 10 shows a preferred fiber optic coupling system.

### DETAILED DESCRIPTION OF THE INVENTION

The present invention is directed to an improved curved reflector for use within an optical display system, particularly, a projection display system and fiber optic light sources. It can be utilized either as part of the projection optic and/or as part of the beam steering and focusing coupling optic. Both applications can benefit from a lightweight, stiff curved reflector.

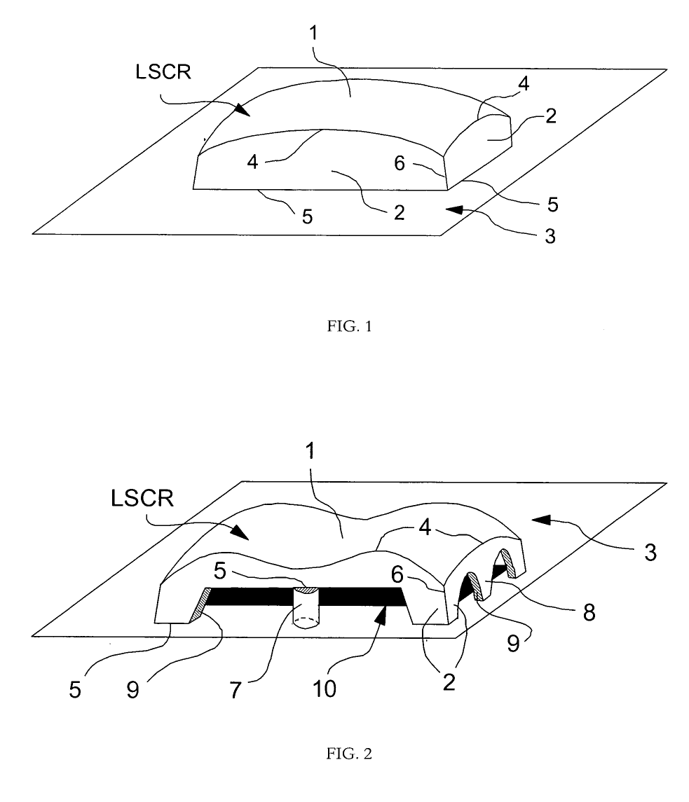

FIG. 1 exhibits a first embodiment of the present invention, a light weight, stiff, curved reflector system (LSCR) comprising a thin concave or convex optical curved surface 1, wherein the optical curved surface 1 further comprises an optical and non-optical side (non-optical side shown in FIG. 1); and at least one thin flange surface 2. The flange surface 2 is in mechanical contact to an optional mounting surface 3. The flange surface(s) 2 are cooperatively connected, preferably mechanically rigidly connected, to the optical surface 1 along the proximal edge 4 and to the optional mounting surface 3 along the distal edge 5 and to each other along the intermediate edge 6 (only some shown). The flange surfaces 2 are oriented substantially perpendicular to the proximal edge 4 of the optical surface 1. In this manner, the LSCR by itself is very resistant to compression and tensile forces along the major dimension of the flange surface 2. When the lamp reflector module (hereafter LRM) is laid to rest on a mounting surface 3, wherein the distal edges 5 are in contact therewith, the assembly thereof is also very resistant against torsion forces even when the LRM structure is very thin compared to its length, width, or height.

FIG. 2 exhibits a second embodiment of the present invention for a LSCR having a both concave and convex shaped optical surface 1, as compared to FIG. 1 illustrating a concave/convex optical surface 1 (depending on perspective) wherein the non-optical side of the optical surface 1 is shown, as is similarly illustrated in FIG. 2. However, FIG. 2 illustrates a mounting post 7 mounted onto the optional mounting surface 3, wherein said post 7 supports the LSCR at the distal edge 5. Alternatively, the flange surface 2 can have a flange mounting support feature 8 supporting the optical surface 1 while in contact to the mounting surface 3. It is preferred that the thickness of the LSCR is substantially uniform for the whole object or preferentially chosen so as to minimize the material (weight) requirement to fulfill a minimum stiffness requirement specifications.

For example, if the LSCR is made with a first preferred manufacturing method, i.e. electroforming with a pure Ni electroforming copy process operated close to a zero stress level over a suitable stainless steel mandrel, the thickness can be typically on the order of 1/500- 1/2000 of the longest dimension of the optical surface thus forming a seamless structure and quasi stress free shape. In a second preferred manufacturing process, the material used in the electroforming process is a Ni alloy, for example NiCo, or other combination chosen in such a manner that they make a stiffer part than the pure Ni material itself Optionally, such a preferred manufacturing process enables the overall material thickness to be further minimized so as to achieve equivalent flexure resistance performance.

Optionally, the optical surface 1 is coated with a reflectivity enhancing thin film, for example enhanced Aluminum or multi layer metal and/or dielectric material comprising high and low index materials deposited with an e-beam and/or sputtering physical vapor deposition process or other equivalent processes.

In another preferred manufacturing process the optical surface 1 is overcoated with a surface roughness reducing thin film, for example UV curing epoxy or higher temperature capable polyimide film prior to the application of a reflectivity enhancing and/or modifying coating.

In another preferred embodiment of the present invention, the side flange surface has a portion 9 of its surface not present, e.g., the height of the flange surface varies, so as to further reduce the material cost, while still providing sufficient stiffness against compressive, tensile, and tensional forces trying to distort the shape of the optical surface 1. More particularly, the total surface area (and thus material cost) of the flange is minimized by varying the height of the flange between the proximal 4 and distal 5 edges.

In a further preferred embodiment of the present invention the back side or non-optical side of the LSCR (i.e. opposite to the optical active side of the optical surface 1), is further stiffened by the coating application of fiberglass resin, carbon fiber matrix embedded into epoxy, structural foam, etc. As such, the material thickness may be further reduced providing that the combination with the back stiffening coating application provides sufficient stiffening resistance for the application at hand. For example, the thickness of the LSCR can be so thin that it might otherwise be subjective to sound vibration, thus enabling the building of an accurate built-in support structure thereby reducing material consumption of the basic LSCR material, for example Ni. Preferentially, such a stiffening-enhancing layer is applied after the vacuum deposition of a reflectivity altering/enhancing film.

As illustrated in FIG. 2 for an inside optical surface 1, the optional cutouts 10 of the mounting surface 3, allows the optical surface to interact with incident light, and perform an imaging and beam steering function.

Another preferred embodiment of the present invention uses a molding process to make the LSCR shape shown in FIGS. 1 and 2, which allows a significant minimization of material consumption while maintaining the desired functional performance. Optional glass fiber filled resins are being used to increase the stiffening of the thin material mold. Draft angles, edge feature, and material delivery gates need to be chosen in such a manner so as to minimize any surface shape distortions of the optical surface 1. It is preferred that low shrinkage thermal setting resins are used for such a molding process, for example BMC 304 or 300 or an equivalent manufactured by Bulk Molding Corporation. A UV curing surface roughness reduction layer (for example UVB553B or equivalent) can be applied to increase the surface reflectivity performance prior to vacuum metallization of the thus achieved LSCR.

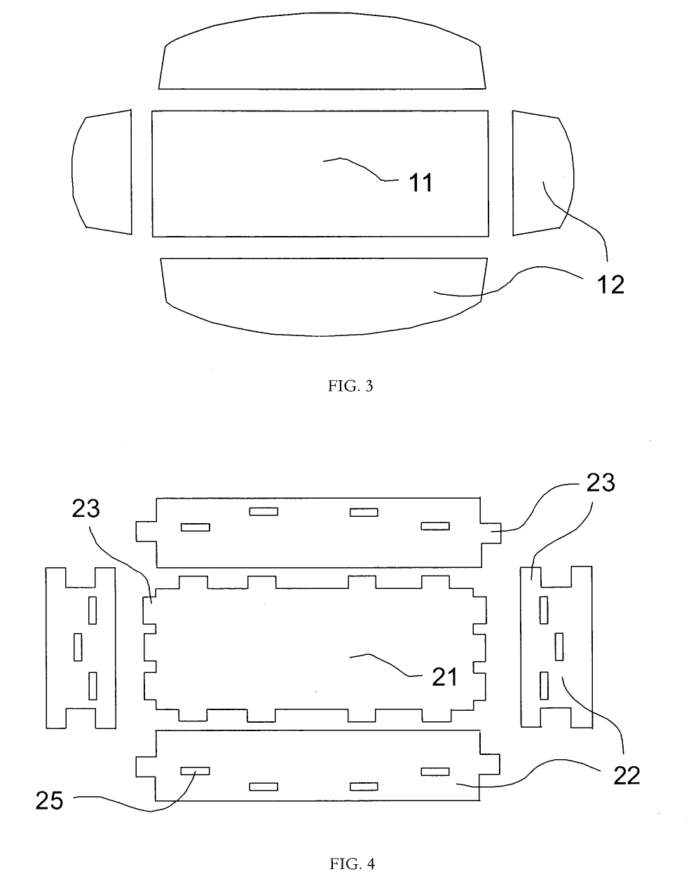

The starting point of a further preferred embodiment of the present invention is shown in FIGS. 3 and 4. FIG. 4 exhibits mostly rectangular shapes with mounting flange tabs 23 and mounting flange slots 25. The thin sheets are cut into the required shapes. Stamping, laser cutting, jet cutting, machining are some of the optional shaping processes suitable to create the basic shape. The optical surface 11 and 21 is preferentially made from an optically smooth (polished) thin sheet that optionally is protected one side by a thin plastic film. The flange surfaces 12 and 22 can be made from the same or different material. Optionally, the optical surfaces 11 and 21, and 12 and 23 can also be molded or slumped sheets of plastic and/or glass.

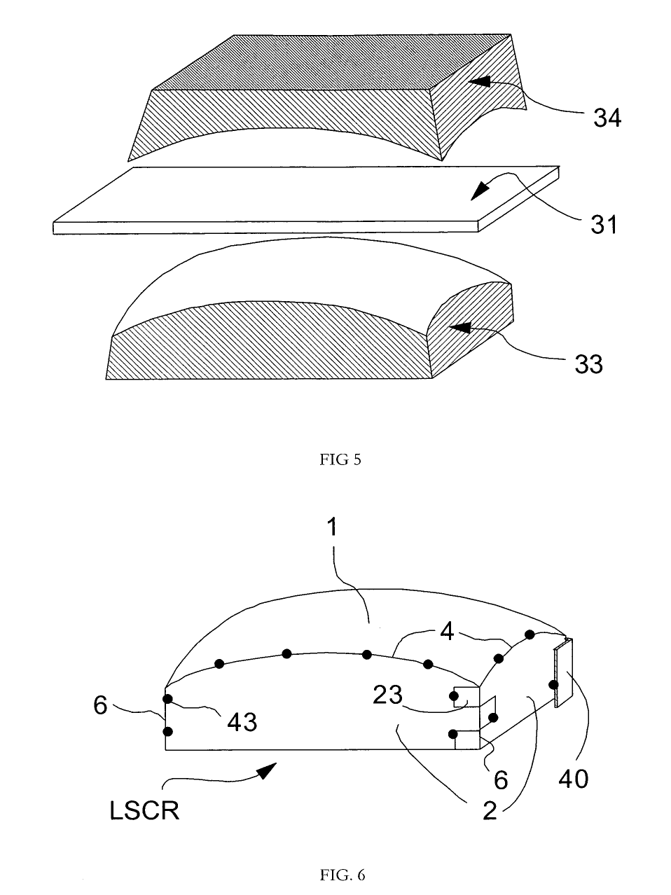

FIG. 5 exhibits a thin sheet 31 that is to be shaped by an optically polished shaping tool 33 with a matching counter tool 34 inside a press and/or heated oven.

FIG. 6 exhibits an assembled and connected LSCR made from individual segments 11/21 and 12/22 or combinations thereof. The intermediate edge 6 is formed between two side flanges 2. Several methods are shown to connect the individual surfaces together at their respective proximal edges 4 and intermediate edges 6. For example, an auxiliary structural support bracket 40 can be used to stiffen the corners. Alternatively, welding, (e.g., spot-, laser- or tack-welding), or gluing of spots 43 may be utilized to stiffen said corners, providing that the spacing frequency is sufficiently dense over the respective edges 4 and 6.

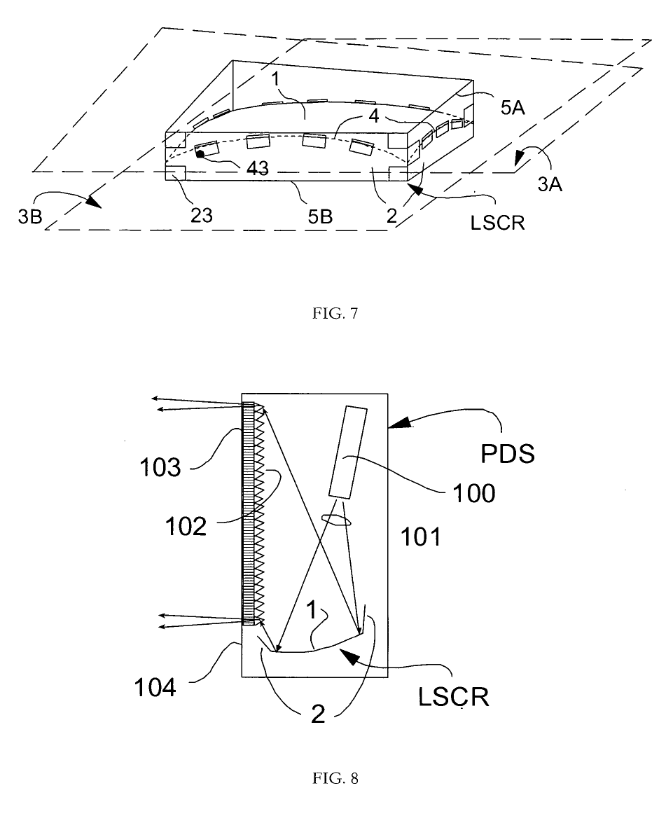

FIG. 7 exhibits an assembled LSCR shape wherein only rectangular sheets 21 and 22 are being used to create the stiffened curved reflector. Two mounting reference surfaces 3A and 3B are being shown below and above the optical surface 1. Optionally, the reference surface formed by the respective edges 5A and 5B are not parallel to the optical surface 1. The mounting flange tabs 23 are inserted in to the mounting flange slots 25, bent around, and connected with a local connection spot 43.

FIG. 8 depicts still another preferred embodiment of the present invention: a LSCR reflector is being used in combination with an illumination light engine 100 that is projected with a projection lens 101, the LSCR with optical surface 1 and side flanges 2, and the beam steering optic 102 onto the projection screen 103. The housing 104 contains all the components thus forming a rear projection display system (PDS) of the present invention.

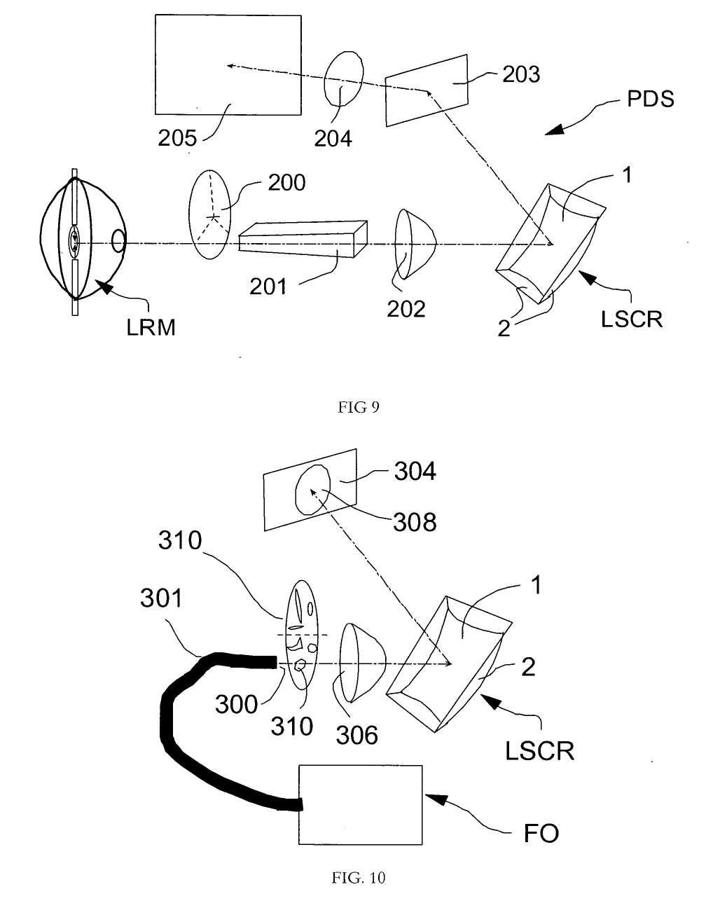

FIG. 9 depicts yet another preferred embodiment of the present invention where a lamp reflector module (LRM) (for example, an étendue efficient LRM as discussed in U.S. Pat. No. 6,356,700 issued to K. Strobl (hereafter Strobl '700), or an elliptical or parabolic LRM) illuminates a color wheel 200, is homogenized by an integrator 201 (for example hollow or solid rectangular integrator or EP102 by K. Strobl), and coupled by an coupling lens 202 and an LSCR onto a display device 203 (for example a reflective DMD or LCOS or a transmissive LCD light valve), whose light output is then projected by a projection lens 204 onto a projection screen 205, thus forming a front projection display system.

U.S. Pat. No. 6,527,396 issued to Shinji et. al. (hereafter Shinji '396) describes such a front projection display system, however, Shinji '396 fails to teach how to build such a reflector or how to maximize the stiffness/weight ratio of such a reflective focusing and beam steering mirror. Optionally, one or more such LSCR coupling reflectors can be used in a rear projection display system both in the illumination and in the projection optical path.

Similarly, such a folding mirror can also be used to beam steer, magnify, and optionally, color filter the output of a fiber optic light guide, and to focus the beam back down to the same or different spot size, depending on the application requirements. Color filtration occurs due to the color reflectivity dependent coating applied to the LSCR shape on the respective optical surface 1 side. The benefit from the utilization of such a LSCR reflector is the light weight and rugged device becomes buildable, and well suitable for fine mechanical work, like surgical and light curing and treatment applications, wherein accurate beam steering is accomplished by visual and manual feedback.

Another preferred manufacturing process of the present invention for such LSCR is to bond, hold, or wedge them at the distal edge 5 onto a mounting surface (preferably a stiff, lightweight plane). The individual shapes 11/21 and 12/22 can be cut first from a foil or thin sheet, and shaped either first individually, and then assembled, or while the optical surface 1 is inside a press-like forming tool 33 and 34.

The benefit of using an electroforming or molding manufacturing process is that one continuous shape can be made that has as many edges, corner and folds as needed to provide the overall structure with sufficient stiffening resistance against normal torque, tensile, and compressive handling forces.

Optionally, the side flanges 2 have additional auxiliary flanges at their respective distal edges 5 so as to further increase the stiffening resistance of the overall structure, thus allowing further material savings.

For example, a 100×10×5 mm rectangular optical surface can be made very stiff and lightweight (<10 g) with suitable optimized Ni electroforming processes with thickness of the LSCR as little as 50 μm and even thinner with NiCo processes.

FIG. 10 shows another embodiment of the preferred invention, wherein a LSCR is used to both redirect and refocus the light emitted from an output surface 300 of a light guide 301 onto an illumination target 304. Optionally, an auxiliary lens 306 is used to change the magnification of the illumination spot 308 at the illumination target 304. Said fiber optic light guide 301 is being illuminated by a Fiber Optic Light source FO. The shape of the curved LSCR can optionally be chosen in such a manner that it also magnifies or minifies the image of the output surface 300 of the light guide 301. Optionally, suitable apertures 310 can be inserted into the light path to shape the profile and/or intensity distribution of the illumination spot 308. A plurality of apertures 310 can be combined on a wheel 312 or slider to facilitate the exchange of one aperture shape to another.

All of the above referenced patents; patent applications and publications are hereby incorporated by reference. Many variations of the present invention will suggest themselves to those of ordinary skill in the art in light of the above detailed description. All such obvious modifications are within the full-intended spirit and scope of the claims of the present application both literally and in equivalents recognized at law, as set forth and claimed hereinbelow.

1. A reflector comprising:
a substantially rectangular body having an optical surface and a non-optical surface; and
a flange having a height, wherein said flange is cooperatively connected to said body about the perimeter, and is further orientated substantially perpendicular to said optical surface.

2. A reflector as in claim 1, wherein said reflector is made from a material having a substantially uniform thickness.

3. A reflector as in claim 1, wherein said reflector is stiff.

4. A reflector as in claim 1, wherein said reflector has a thickness in the range of about 1/500 to about 1/2000 of the longest dimension thereof.

5. A reflector as in claim 1, wherein said reflector has a thickness of about 50 μm.

6. A reflector as in claim 1, wherein said reflector is made from a material selected from the group consisting of: Ni, and NiCo.

7. A reflector as in claim 1, wherein said reflector is made from a material having the characteristics of a Ni alloy.

8. A reflector as in claim 1, wherein said body is curved.

9. A reflector as in claim 1, wherein said optical surface is coated with a reflectivity enhancing thin film.

10. A reflector as in claim 1, wherein said optical surface is coated with a surface roughness reducing thin film.

11. A reflector as in claim 1, wherein said flange has a varying height.

12. A reflector as in claim 1, wherein said non-optical rear surface has a stiffening coating.

13. A reflector as in claim 12, wherein said stiffening coating is selected from the group consisting of: a fiberglass resin, a carbon fiber matrix embedded in epoxy, and structural foam.

14. A reflector comprising:
a non-linear body having an optical surface, and a flange cooperatively connected thereto via a connection means, said flange which extends radially outward therefrom; wherein the distal edge of said flange varies in dimension from said connection; said body further having a substantially uniform thickness of about 1/500 to about 1/2000 of the longest dimension of the optical surface.

15. A reflector as in claim 14, wherein said optical surface is coated.

16. A reflector as in claim 14, wherein said reflector is made from a material based on Ni.

17. A reflector as in claim 14, wherein said body is coated with a stiffening coating.

18. A reflector as in claim 14, wherein said means includes: gluing, welding, crimping, riveting, malleable flanges, and interlocking features.

19. A reflector as in claim 14, wherein said body is cooperatively connected to said flange between the edges of the flange.

20. A method of manufacturing a reflector which comprises:
a. Fabricating preselected thin material into predetermined sizes;
b. Forming said sizes into shape;
c. Assembling said sizes into a unit;
d. Optionally, stiffening said unit via welding.

21. A method of manufacturing a reflector as in claim 20, wherein said stiffening comprises gluing, and electroforming.

22. A method of manufacturing a reflector as in claim 20, wherein said forming process comprises stamping, which optionally includes a placing said material onto a shaping tool prior to pressing.

23. A method of manufacturing a reflector as in claim 20, further comprising overcoating the optical surface with a surface roughness reducing film prior to coating the optical surface with a reflectivity enhancing and/or modifying coating.

24. A method of manufacturing a reflector as in claim 20, further comprising overcoating the non-optical surface with a material selected from the group consisting of: fiberglass resin, carbon fiber matrix embedded in epoxy, and structural foam.

25. A method of manufacturing a reflector as in claim 20, wherein said forming process comprises stamping, laser cutting, jet cutting, and machining.
